(19) United States
(12) Patent Application Publication
(10) Pub. No.: US 2006/0277767 A1
(43) Pub. Date: Dec. 14, 2006

(54) Razor blades

(76) Inventors: Shuwei Sun, Framingham, MA (US); Neville Sonnenberg, Newton, MA (US); John Madeira, Assonet, MA (US)

Correspondence Address: FISH & RICHARDSON P.C., P.O. BOX 1022, MINNEAPOLIS, MN, 55440-1022, US

(21) Appl. No.: 11/152,116

(22) Filed: Jun. 14, 2005

(51) Int. Cl. B26B 21/54

(52) U.S. Cl. 30/346.54; 30/50

(57) ABSTRACT

A razor blade including a substrate with a cutting edge defined by a sharpened tip and adjacent facets, a layer of hard coating on the cutting edge, an overcoat layer of chromium nitride on the layer of hard carbon coating, and an outer layer of polytetrafluoroethylene coating over the overcoat layer.

### TECHNICAL FIELD

The invention relates to improvements to razors and razor blades.

### BACKGROUND

A razor blade is typically formed of a suitable substrate material such as stainless steel, and a cutting edge is formed with a wedge-shaped configuration with an ultimate tip having a radius less than about 1000 angstroms, e.g., about 200-300 angstroms. Hard coatings such as diamond, amorphous diamond, diamond-like carbon (DLC) material, nitrides, carbides, oxides or ceramics are often used to improve strength, corrosion resistance and shaving ability, maintaining needed strength while permitting thinner edges with lower cutting forces to be used. Polytetrafluoroethylene (PTFE) outer layer can be used to provide friction reduction. Interlayers of niobium or chromium containing materials can aid in improving the binding between the substrate, typically stainless steel, and hard carbon coatings, such as DLC. Examples of razor blade cutting edge structures and processes of manufacture are described in U.S. Pat. Nos. 5,295,305; 5,232,568; 4,933,058; 5,032,243; 5,497,550; 5,940,975; 5,669,144; EP 0591334; and PCT 92/03330, which are hereby incorporated by reference.

In use, the ultimate tip of the edges having hard coatings and polytetrafluoroethylene outer layers can become more rounded after repeated shaves such that there is an increase in the tip radius and a generally perceived decrease in shaving performance.

U.S. Pat. No. 6,684,513 describes razor blades having a chromium containing overcoat layer to address these issues.

### SUMMARY

In one aspect, the invention features, in general, a razor blade including a substrate with a cutting edge defined by a sharpened tip and adjacent facets, a layer of hard coating on the cutting edge, an overcoat layer of chromium nitride on the layer of hard coating, and an outer layer of polytetrafluoroethylene coating on the overcoat layer. The inventors have found that chromium nitride provides particularly good adhesion of the polytetrafluoroethylene coating. As a result, the polytetrafluoroethylene coating remains adhered to the blade after repeated shaving, increasing the number of comfortable shaves that can be obtained with the blade. Moreover, chromium nitride is hard, strong, and corrosion resistant, resulting in excellent edge strength and enhanced shaving performance.

In another aspect the invention features, in general, a shaving razor including a handle and a razor head with a blade having a substrate with a cutting edge defined by a sharpened tip and adjacent facets, a layer of hard coating on the cutting edge, an overcoat layer of chromium nitride on the layer of hard coating, and an outer layer of polytetrafluoroethylene coating on the overcoat layer.

Particular embodiments of the invention may include one or more of the following features. In particular embodiments, the hard coating material can be made of carbon containing materials (e.g., diamond, amorphous diamond or DLC), nitrides, carbides, oxides or other ceramics. The hard coating layer can have a thickness less than 2,000 angstroms. The overcoat layer can be made of chromium nitride having a percentage ratio of carbon to nitrogen of 10% to 50%. Preferably, the chromium nitride has a nitrogen content of from about 25 to 35 atomic percent. The overcoat layer can be between 100 and 600 angstroms thick, e.g., 200 to 400 angstroms. The blade can include an interlayer between the substrate and the layer of hard coating. The interlayer can include niobium or a chromium containing material. The polytetrafluoroethylene can be KRYTOX LW1200™, available from DuPont. The PTFE outer layer can be between 100 and 5000 angstroms thick.

In another aspect, the invention features, in general, making a razor blade by providing a substrate with a cutting edge defined by a sharpened tip and adjacent facets, adding a layer of hard coating on the cutting edge, adding an overcoat layer of chromium nitride on the layer of hard coating, and adding an outer layer of polytetrafluoroethylene coating over the overcoat layer.

Particular embodiments of the invention may include one or more of the following features. In particular embodiments the layers can be added by reactive physical vapor deposition (e.g., magnetron sputtering or cathodic arc) or by chemical vapor deposition. The deposition of chromium nitride can include arc deposition. Arc deposition may be performed using a cathodic arc current between about 100 Amps and 200 Amps and a substrate bias of −40V to −100V. Deposition may be performed at a pressure of 10⁻⁶ Torr to 10⁻² Torr, and may be performed in a nitrogen or nitrogen/argon atmosphere. If a mix of nitrogen and argon is used, the N to Ar ratio may be from about 1:3 to 3:1. Alternatively, an appropriate RF bias or DC bias scheme can be used to achieve an equivalent chromium nitride layer by reactive magnetron sputtering under nitrogen or argon/nitrogen mixes.

Embodiments of the invention may include one or more of the following advantages. The use of a chromium nitride overcoat layer provides improved adhesion of the polytetrafluorethylene outer layer to the hard coating layer. The razor blade has improved edge strength provided by hard coating and has reduced tip rounding with repeated shaves. Reduced tip rounding minimizes the increase in cutting force thereby maintaining excellent shaving performance. The razor blade has excellent shaving characteristics from the first shave onwards.

The details of one or more embodiments of the invention are set forth in the accompanying drawings and the description below. Other features, objects, and advantages of the invention will be apparent from the description and drawings, and from the claims.

### DESCRIPTION OF DRAWINGS

FIG. 1 is a vertical sectional view of a cutting edge portion of a razor blade.

FIG. 2 is a perspective view of a shaving razor including the FIG. 1 razor blade.

### DETAILED DESCRIPTION

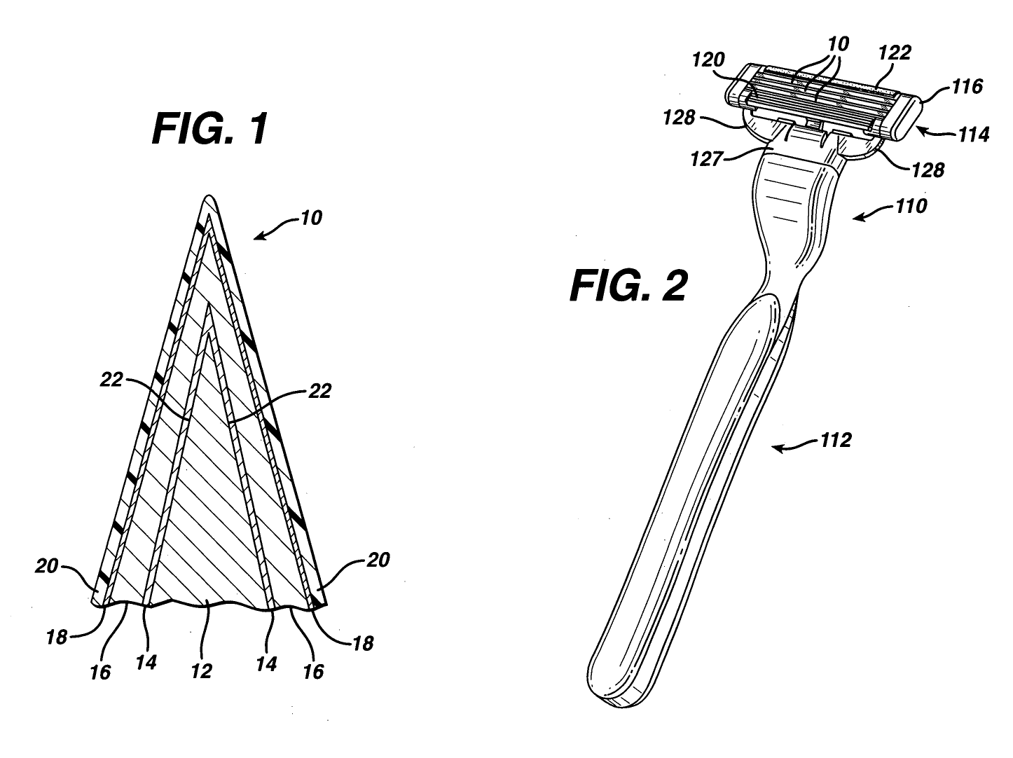

Referring to FIG. 1, there is shown razor blade 10 including substrate 12, interlayer 14, hard coating layer 16, overcoat layer 18, and outer layer 20. The substrate 12 is typically made of stainless steel (though other substrates can be employed) and has an ultimate edge sharpened to a tip radius of less than 1,000 angstroms, preferably 200 to 300 angstroms, and has a profile with side facets 22 at an included angle of between 15 and 30 degrees, preferably about 19 degrees, measured at 40 microns from the tip.

Interlayer 14 is used to facilitate bonding of the hard coating layer to the substrate. Examples of suitable interlayer material are niobium and chromium containing material. A particular interlayer is made of niobium greater than 100 angstroms and preferably less than 500 angstroms thick. PCT 92/03330 describes use of a niobium interlayer.

Hard coating layer 16 provides improved strength, corrosion resistance and shaving ability and can be made from carbon containing materials (e.g., diamond, amorphous diamond or DLC), nitrides (e.g., boron nitride, niobium nitride or titanium nitride), carbides (e.g., silicon carbide), oxides (e.g., alumina, zirconia) or other ceramic materials. The carbon containing materials can be doped with other elements, such as tungsten, titanium or chromium by including these additives, for example in the target during application by sputtering. The materials can also incorporate hydrogen, e.g., hydrogenated DLC. Preferably coating layer 16 is made of diamond, amorphous diamond or DLC. A particular embodiment includes DLC less than 2,000 angstroms, preferably less than 1,000 angstroms. DLC layers and methods of deposition are described in U.S. Pat. No. 5,232,568. As described in the “Handbook of Physical Vapor Deposition (PVD) Processing,” DLC is an amorphous carbon material that exhibits many of the desirable properties of diamond but does not have the crystalline structure of diamond.

Overcoat layer 18 is used to reduce the tip rounding of the hard coated edge and to facilitate bonding of the outer layer to the hard coating while still maintaining the benefits of both. Overcoat layer 18 is made of chromium nitride. The chromium nitride may have a Cr/N percentage ratio of about 10% to 50%, stoichiometric or non-stoichiometric. In some embodiments the chromium nitride may include about 30 atomic percent nitrogen. In some embodiments the chromium nitride is arc deposited in a layer about 200-400 angstroms thick. Blade 10 has a cutting edge that has less rounding with repeated shaves than it would have without the overcoat layer.

Outer layer 20 is used to provide reduced friction and includes polytetrafluoroethylene and is sometimes referred to as a telomer. A particular polytetrafluoroethylene material is Krytox LW 1200 available from DuPont. This material is a nonflammable and stable dry lubricant that consists of small particles that yield stable dispersions. It is furnished as an aqueous dispersion of 20% solids by weight and can be applied by dipping, spraying, or brushing, and can thereafter be air dried or melt coated. The layer is preferably less than 5,000 angstroms and could typically be 1,500 angstroms to 4,000 angstroms, and can be as thin as 100 angstroms, provided that a continuous coating is maintained. Provided that a continuous coating is achieved, reduced telomer coating thickness can provide improved first shave results. U.S. Pat. Nos. 5,263,256 and 5,985,459, which are hereby incorporated by reference, describe techniques which can be used to reduce the thickness of an applied telomer layer.

Razor blade 10 is made generally according to the processes described in the above referenced patents. A particular embodiment includes a niobium interlayer 14, DLC hard coating layer 16, chromium nitride overcoat layer 18, and Krytox LW1200 polytetrafluoroethylene outer coat layer 20. Chromium nitride overcoat layer 18 is deposited to a minimum of 100 angstroms and a maximum of 600 angstroms. It is deposited by arc deposition. Arc deposition may be performed using a cathodic arc current between about 100 Amps and 200 Amps, e.g., about 150 Amps, and a substrate bias of −40V to −100V, e.g., about −65V. Deposition may be performed at a pressure of 10⁻⁶ Torr to 10⁻² Torr, e.g., about 10⁻⁴ Torr, and may be performed in a nitrogen or nitrogen/argon atmosphere. If a mix of nitrogen and argon is used, the N to Ar ratio may be from about 1:3 to 3:1.

Blade 10 preferably has a tip radius of about 200-400 angstroms, measured by SEM after application of overcoat layer 18 and before adding outer layer 20.

Referring to FIG. 2, blade 10 can be used in shaving razor 110, which includes handle 112 and replaceable shaving cartridge 114. Cartridge 14 includes housing 116, which carries three blades 10, guard 120 and cap 122. Blades 10 are movably mounted, as described, e.g., in U.S. Pat. No. 5,918,369, which is incorporated by reference. Cartridge 114 also includes interconnect member 124 on which housing 116 is pivotally mounted at two arms 128. Interconnect member 124 includes a base 127 which is replaceably connected to handle 112. Alternatively, blade 10 can be used in other razors having one, two or more than three blades, double-sided blades, and razors that do not have movable blades or pivoting heads where the cartridge is either replaceable or permanently attached to a razor handle.

In use, razor blade 10 has excellent shaving characteristics from the first shave onwards. Blade 10 has improved edge strength provided by hard coating and has reduced tip rounding with repeated shaves provided by the overlayer coating while maintaining excellent shave characteristics.

Other embodiments are within the scope of the following claims.

For example, if desired other deposition techniques may be used, e.g., magnetron sputtering using a DC bias (more negative than −50 volts and preferably more negative than −200 volts) and pressure in the milliTorr range using nitrogen or argon/nitrogen mixes or an appropriate RF bias.

What is claimed is:

1. A razor blade comprising
a substrate with a cutting edge defined by a sharpened tip and adjacent facets,
a layer of hard coating on said cutting edge,
an overcoat layer of chromium nitride on said layer of hard coating, and
an outer layer of polytetrafluoroethylene coating over said overcoat layer.

2. The blade of claim 1 wherein said hard coating is made of a carbon containing material.

3. The blade of claim 2 wherein said carbon containing material comprises diamond.

4. The blade of claim 2 wherein said hard carbon coating comprises diamond-like carbon material.

5. The blade of claim 2 wherein said hard carbon coating comprises amorphous diamond material.

6. The blade of claim 1 wherein said overcoat layer consists of chromium nitride having a percentage ratio of carbon to nitrogen of 10% to 50%.

7. The blade of claim 1 wherein said overcoat layer has a thickness of from about 100 to 600 angstroms.

8. The blade of claim 7 wherein said overcoat layer has a thickness of from about 200 to 400 angstroms.

9. The blade of claim 6 wherein the chromium nitride has a nitrogen content of from about 25 to 35 atomic percent.

10. The blade of claim 1 further comprising an interlayer between said substrate and said layer of hard carbon coating.

11. The blade of claim 10 wherein said interlayer comprises niobium.

12. The blade of claim 10 wherein said interlayer comprises a chromium containing material.

13. The blade of claim 4 further comprising a niobium interlayer between said substrate and said hard coating.

14. The blade of claim 1 wherein said hard coating layer has a thickness less than 2,000 angstroms.

15. The blade of claim 1 wherein said outer layer is between 100 and 5,000 angstroms thick.

16. The blade of claim 1 wherein said blade has a cutting edge that has less rounding with repeated shaves than it would have without said overcoat layer.

17. A shaving razor comprising
a handle,
a housing connected to said handle, and
at least one razor blade mounted in said housing, said blade comprising
a substrate with a cutting edge defined by a sharpened tip and adjacent facets,
a layer of hard coating on said cutting edge,
an overcoat layer of chromium nitride on said layer of hard coating, and
a outer layer of polytetrafluoroethylene coating over said overcoat layer.

18. The razor of claim 17 wherein said hard coating is made of a carbon containing material.

19. The razor of claim 17 further comprising a niobium interlayer between said substrate and said hard coating.

20. A method of making a razor blade comprising
providing a substrate with a cutting edge defined by a sharpened tip and adjacent facets,
adding a layer of hard coating on said cutting edge,
adding an overcoat layer of chromium nitride on said layer of hard coating, and
adding an outer layer of polytetrafluoroethylene coating over said overcoat layer.

21. The method of claim 20 wherein said adding a layer of hard coating includes vapor depositing a carbon containing material.

22. The method of claim 20 wherein said adding an overcoat layer includes arc depositing said chromium nitride.

23. The method of claim 22 wherein arc deposition is performed using a cathodic arc current between about 100 Amps and 200 Amps.

24. The method of claim 22 wherein arc deposition is performed using a substrate bias of −40V to −100V.

25. The method of claim 22 wherein arc deposition is performed at a pressure of 10⁻⁶ Torr to 10⁻² Torr.

26. The method of claim 22 wherein arc deposition is performed in a nitrogen atmosphere.

27. The method of claim 22 wherein arc deposition is performed in a nitrogen/argon atmosphere.

28. The method of claim 27 wherein the ratio of nitrogen to argon is from about 1:3 to 3:1.
